(19) United States
(12) Patent Application Publication
(10) Pub. No.: US 2003/0107141 A1
(43) Pub. Date: Jun. 12, 2003

(54) Method and an apparatus for the manufacture of well equipment with permanently mounted ladder steps

(76) Inventor: S?oslash;ren Brorsbøl, Ansager (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/203,907

(22) PCT Filed: Feb. 22, 2001
(86) PCT No.: PCT/DK01/00124

(30) Foreign Application Priority Data
Feb. 23, 2000 (DK) PA 200000285

(51) Int. Cl. E04B 1/16; B28B 7/30

(52) U.S. Cl. 264/31; 264/40.1; 264/313; 425/126.1; 425/517

(57) ABSTRACT

The invention relates to a method for the manufacture of well equipment with permanently mounted ladder steps, and wherein the method uses mould parts for forming a mould cavity, which mould parts comprise mould elements that will, following discharge of the cast well equipment, leave a number of mounting apertures in the well equipment, which mounting apertures are located in such a manner that the anchoring parts of the ladder steps can be driven thereinto. The invention also relates to an apparatus for exercising the method, wherein the apparatus comprises a frame with a first arm on which a number of ladder-step grippers are configured, each of which being configured for receiving and securing at least one ladder step. The frame of the apparatus also comprises holder-on means that extend opposite the ladder-step grippers, and the apparatus comprises means for forming a substantially continuous and uninterrupted reduction of the distance between the ladder-step grippers and the holder-on means, and means for discountinuing this displacement at a predetermined distance between the ladder-step grippers and the holder-on means.

The present invention relates to a method and an apparatus for the manufacture of well equipment with permanently mounted ladder steps, said method comprising filling of a mould cavity formed by means of a number of mould parts that comprise at least a mould core and an outer mould, and wherein the mould core is removed following filling of the mould cavity, whereupon one or more ladder steps—each of which being provided with suitable anchoring means—is/are driven into the well equipment thereby removed from the mould by a substantially continuous and uninterrupted movement of the anchoring means of the ladder steps into the well equipment.

Well equipment of the kind described above is most often cast in concrete, and the permanently mounted ladder steps serve to facilitate ascending and descending in the well equipment positioned in the ground. Well equipment of this kind is therefore often designated manholes.

It is a recurring task in connection with the manufacture of well equipment to develop processes and process apparatuses that enable rational production of well equipment.

Thus, U.S. Pat. No 4,075,272 teaches an apparatus and a method of the kind described above, whereby the well equipment is provided with a number of ladder steps following removal of the mould core from the ready-cast well equipment by the steps being, by means of an apparatus intended therefor, secured in a number of grippers that will, in a continuous and uninterrupted movement, press the ladder step into the still soft concrete material, and wherein the previously known manual mounting processes are thus avoided, in which a person hammers the ladder steps into the well equipment by means of a sledge hammer.

It is a problem in connection with the prior art process according to U.S. Pat. No. 4,075,272, however, that the driving of the ladder steps into the soft material involves a risk that considerably weakened areas will form in the concrete as a consequence of a major part of the material that is compacted and removed from the mould being—in the area around the place where the ladder step is pressed into the concrete—displaced to provide space for the anchoring means on the ladder step, and that weakening lines may thus unintentionally occur in the set concrete around the places where the ladder step protrudes into the concrete; said weakening lines being of such nature that, in a worst-case scenario, there is a risk of the ladder step being, along with a part of the concrete material around same, torn from the well equipment, simply by a load being imposed on the ladder step, but also of small cracks being formed in the concrete with an ensuing increased risk of humidity penetrating into the anchoring means on the ladder steps with an ensuing risk of corrosion.

It is therefore the object of the present invention to provide a method and an apparatus that will, to a higher degree than the prior art, ensure that the permanently mounted ladder steps remain reliably anchored in the well equipment in the short run as well as in the long run.

This is accomplished by the method according to the present invention in that the moulding process uses mould parts for forming said moulding cavity, said mould parts comprising mould elements that will, following discharge from the mould of the cast well equipment, leave a number of mounting apertures in the well equipment, which mounting apertures are located in such a manner that the anchoring means of the ladder steps can be driven there into.

Hereby the amount of concrete material to be displaced within the well equipment by driving of ladder steps into the well equipment is reduced whereby the risk of crack formation and the like is reduced considerably.

In order to ensure uniform mounting apertures in all cast units and thus to achieve a higher degree of certainty that mounted ladder steps are securely held, the mounting apertures formed in the moulding process are advantageously subjected to follow-up treatment by a further drilling procedure by means of a drilling device intended therefor.

An alternative simple way of ensuring that the apertures formed in the moulding process are uniform can be achieved provided the mould elements that produce the mounting apertures in the well equipment consist of a number of cores that will, during the moulding process, be secured in the mould cavity by means of, and by these mould elements not being removed until the well equipment is completely or partially discharged from the mould core.

Particularly advantageously, the ladder steps are not driven into the well equipment until the cast material well equipment has set sufficiently to ensure that the driving of ladder steps into the mounting apertures will not cause flow or displacement of the casting material around the mounting apertures.

Hereby the driving of ladder steps can further advantageously be performed after removal of the outer mould from the finished well equipment whereby it is possible to remove the outer mould from the cast well equipment at an earlier stage. Hereby economies are obtained in terms of process equipment since the outer mould can participate in a renewed moulding process more quickly.

Particularly advantageously the moulding process uses mould elements to form the mounting apertures, which mould elements are left in the well equipment after discharge of the well equipment from the mould, and wherein the mould elements are provided with anchoring apertures that are configured with a view to receiving and securing the anchoring means configured on the ladder steps, and wherein the ladder steps are, following discharge of the well equipment with cast-in mould elements, driven into the anchoring apertures of the mould elements. Thus, it is hereby ensured to an even higher degree that the concrete around the mounting apertures is not destroyed, the mould elements being per se able to act as reinforcing elements.

Additionally the mould elements can each advantageously be constituted of a substantially cylindrical insert that is preferably made of form-final plastics, such that the mould elements are hereby able to deform plastically and/or elastically when ladder steps are driven into each of the mould elements.

According to a preferred embodiment of the method, the ladder steps are driven into the well equipment by means of an apparatus that comprises a frame on which an arm is configured on which a number of ladder-step grippers are arranged, each of which being configured for receiving and securing at least one ladder step, and wherein the frame of the apparatus further comprises holder-on means that extend opposite the above-mentioned ladder-step grippers, and wherein the apparatus comprises means for forming a substantially continuous and uninterrupted displacement of the ladder-step grippers in a direction towards the holder-on means, and means for stopping this displacement at a predetermined distance between the ladder-step grippers and the holder-on means. Hereby an efficient and at least partially automatable process is obtained that can, relatively quickly, drive several ladder steps simultaneously into the well equipment.

In order to ensure against a risk arising, in said automated process, of damaging ladder steps and well equipment, the location of the mounting apertures in the well equipment is conveniently found by means of sensors intended therefor, and by the ladder steps being, prior to being driven into the mounting apertures, displaced with a view to locating each ladder step opposite the mounting apertures into which they are to be driven.

As referred to above, the present invention also relates to an apparatus for exercising the method, which apparatus comprises a frame on which is configured a first arm on which a number of ladder-step grippers are arranged that are each configured for receiving and securing at least one ladder step, and wherein the apparatus in characterised in that the apparatus frame is also configured with holder-on means that extend opposite said ladder-step grippers, and wherein the apparatus comprises means for forming a substantially continuous and uninterrupted reduction of the distance between the ladder-step grippers and the holder-on means, and ladder-step grippers and the holder-on means, and means for stopping this displacement at a predetermined distance between the ladder-step grippers and the holder-on means.

According to a preferred embodiment the ladder-step grippers on the apparatus are solidly mounted on the first arm, and the means for forming the substantially continuous and uninterrupted reduction of the distance between the ladder-step grippers and the holder-on means are constituted by one or more drive devices that are configured for relative displacement of the first arm with the ladder-step grippers mounted on that arm as a rigid unit in a direction towards the holder-on means. Hereby it is accomplished that the first arm can be configured to be relatively slim, such that the arm can be introduced into well equipment having relatively small diameters, it being hereby avoided that it is necessary to provide the first arm with voluminous drive means in the form of eg horizontal, hydraulic cylinders at each ladder-step gripper with a view to displacing the individual ladder steps into the well equipment.

Besides, the apparatus can conveniently comprise a yoke, which yoke has a spacer element mounted in the frame of the apparatus, and wherein the spacer element features two downwardly extending arms that are arranged at an essentially fixed mutual distance on the spacer element, and of which the one arm constitutes said first arm and the second arm constitutes said holder-on means. An extremely stable construction is hereby obtained that is able to effectively absorb the relatively powerful forces that are necessary to accomplish simultaneous driving-in of several ladder steps in a continuous and uninterrupted movement.

The means for driving the ladder steps into the well equipment can hereby advantageously consist of means that are configured with a view to displacement of the holder-on means away from the second arm of the yoke and in a direction towards the first arm.

Advantageously, the apparatus according to the invention can be configured such that the first arm is located substantially vertically displaceable relative to the apparatus frame. Hereby the individual ladder steps can, in a simple manner, be raised and lowered relative to the well interior and thereby it is accomplished ia that ladder steps can be located at the desired height in relation to the well equipment in alignment with optionally pre-formed mounting apertures in the well equipment.

Besides, the apparatus can additionally and advantageously comprise a device for supporting the well equipment, which device is rotatably arranged relative to the apparatus frame, such that the well equipment can be rotated about a substantially vertical shaft that extends within the well equipment walls. Hereby the correct mutual positioning of mounting apertures, if any, in the well equipment can in a simple manner be effected opposite the ladder steps that are secured in the ladder-step grippers.

In order to compensate for differences in tolerances, if any, in the well equipment the ladder-step grippers are particularly conveniently configured such that the ladder steps secured in the ladder-step grippers can be displaced individually a limited distance in all directions relative to the first arm.

Besides, the ladder-step grippers can conveniently be mounted on the first arm at a different distance there from, such that they can be mounted at a distance from the first arm that corresponds to the internal contour of the well equipment.

A preferred embodiment of the invention will now be described in further detail with reference to the drawing, wherein:

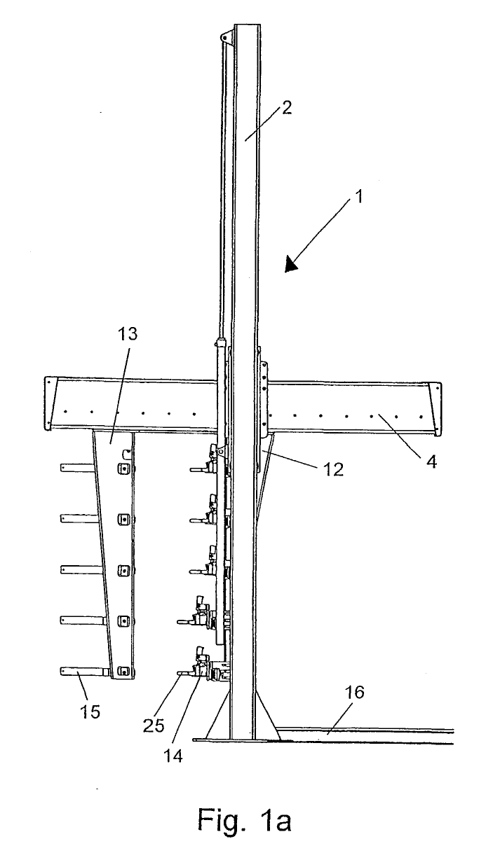

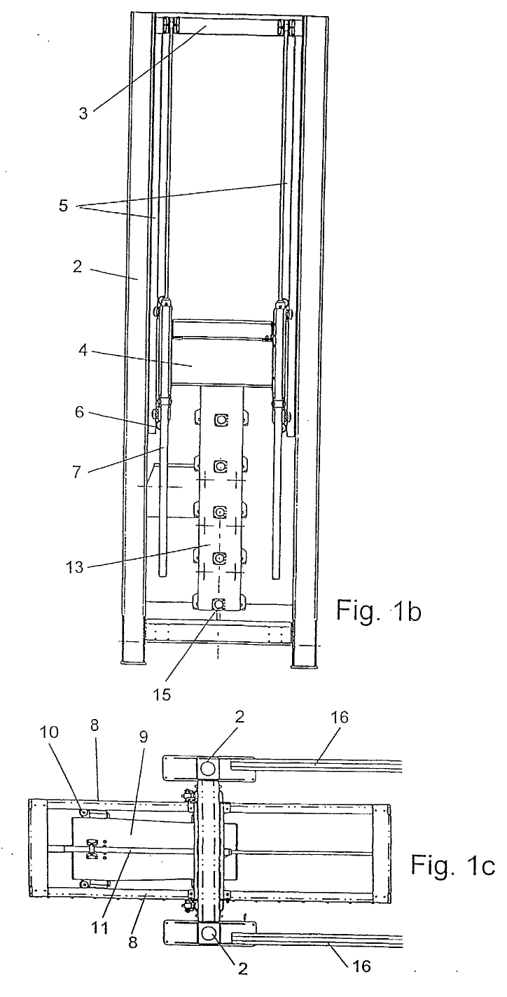

FIGS. 1a, b and c show a first portion of an apparatus according to the present invention in a state that corresponds to an early process step by mounting of ladder steps in well equipment, and which apparatus is seen from a first side, a second side and from the top, respectively.

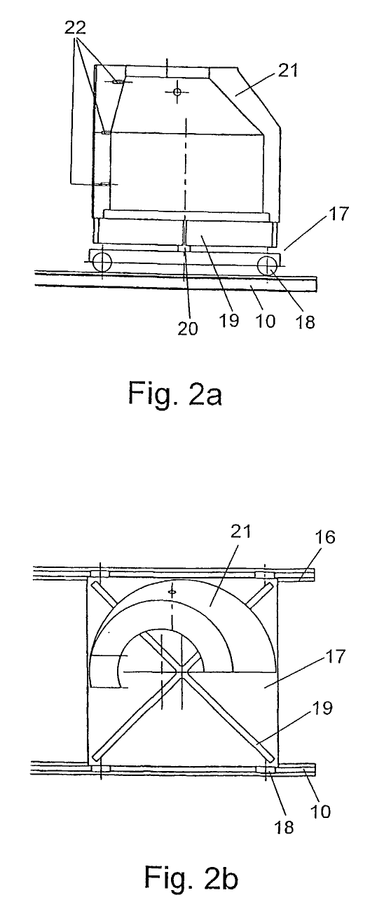

FIGS. 2a and b show a second portion of an apparatus according to the present invention in the form of a carriage with a piece of well equipment according to the invention located thereon.

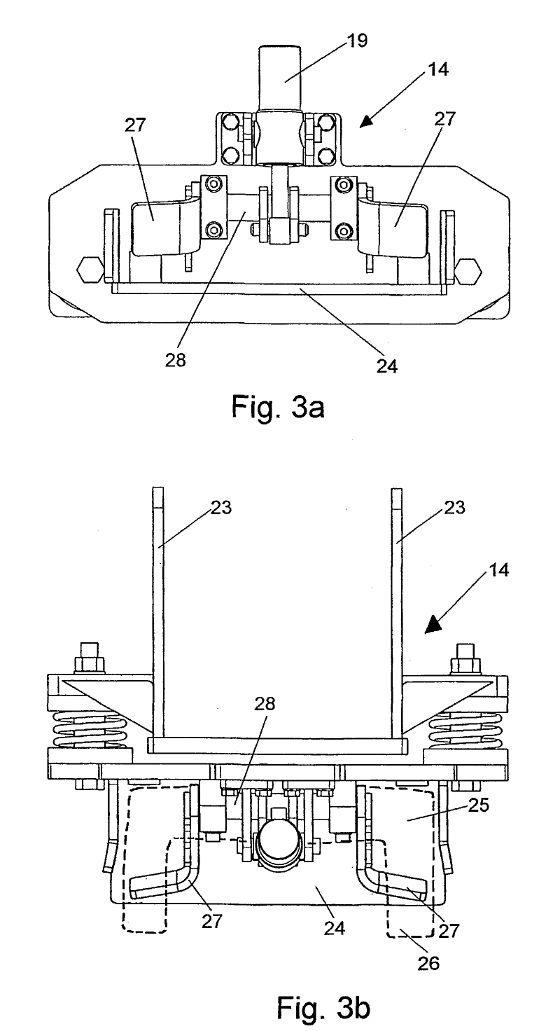

FIGS. 3a and b show a ladder-step gripper of the type shown in FIGS. 1a, b and c in an enlarged view and seen from the front and from above, respectively.

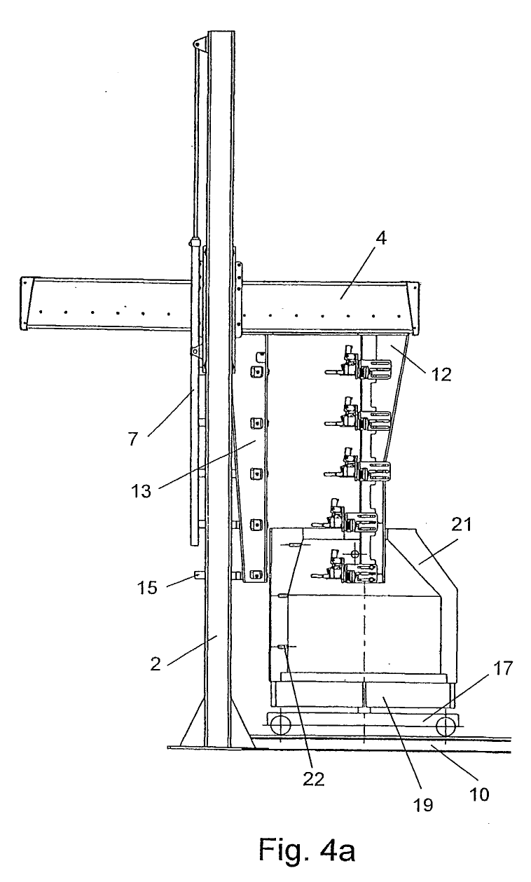

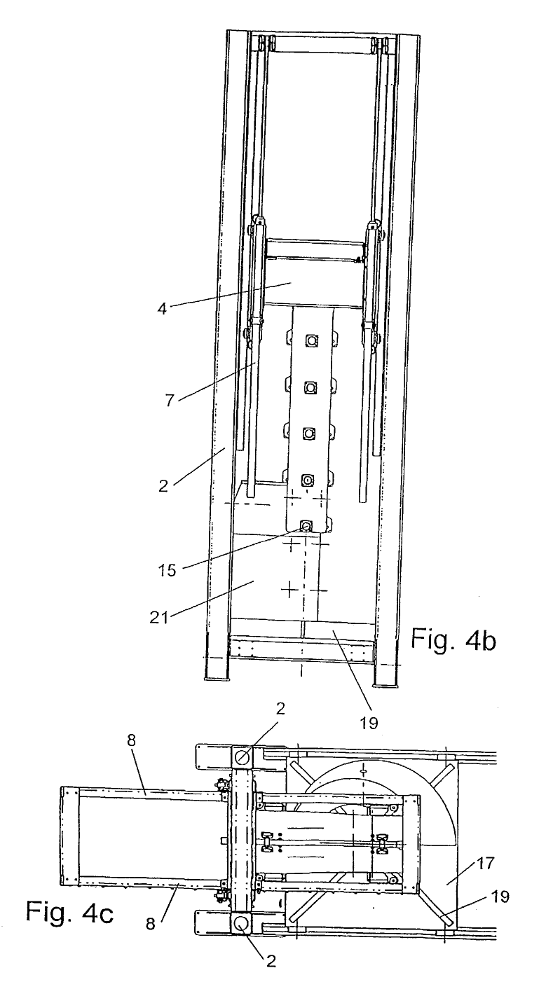

FIGS. 4a, b and c show the portion of the apparatus according to the invention shown in FIGS. 1a, b and c and 2a and b in a state that corresponds to a later process step relative to the one shown in FIGS. 1a, b and c in the mounting of ladder steps in well equipment, and which apparatus is seen from a first side, a second side and from above, respectively.

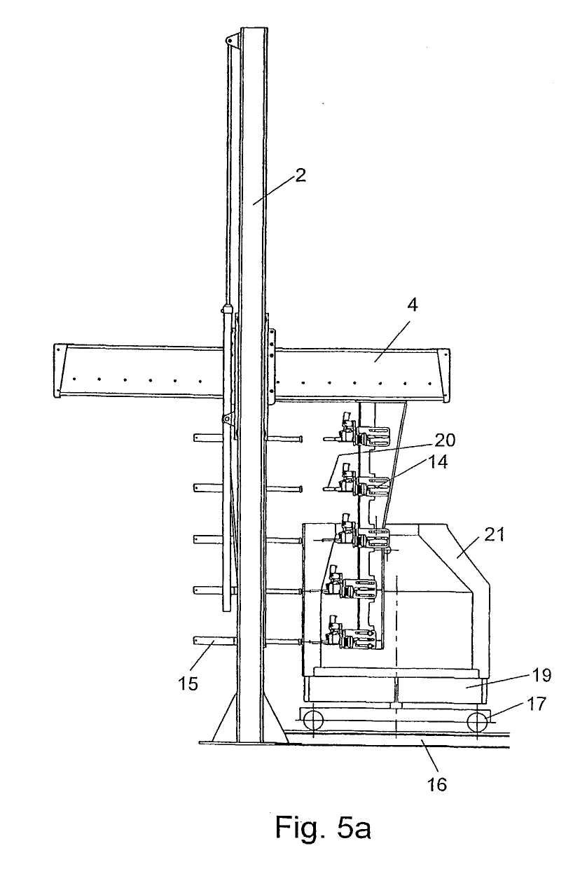

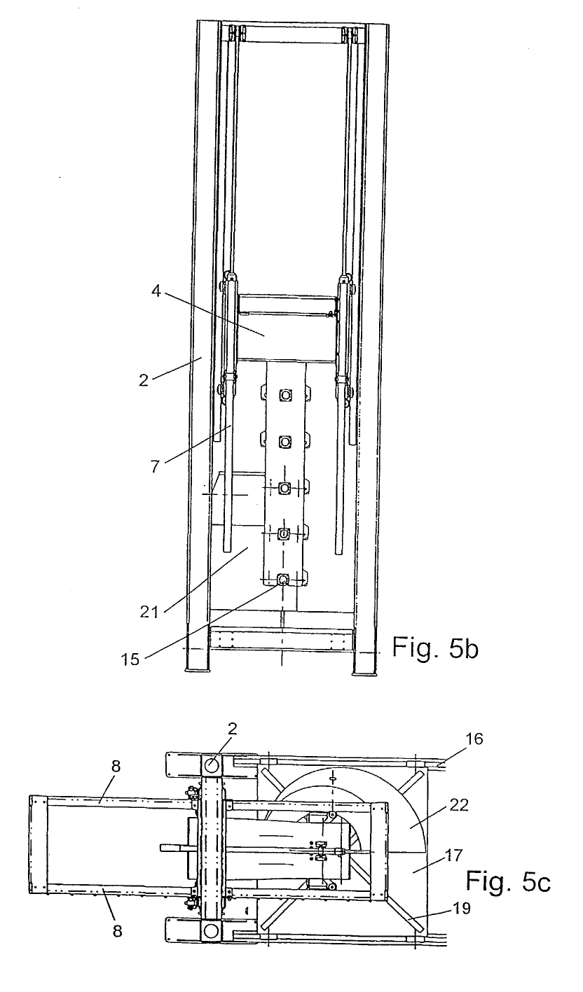

FIGS. 5a, b and c show the portion shown in FIGS. 4a, b and c of an apparatus according to the present invention in a state that corresponds to a later process step relative to the one shown in FIGS. 4a, b and c in the mounting of ladder steps in well equipment, and which apparatus is seen from a first side, a second side and from above, respectively.

Thus, FIGS. 1a, b and c illustrate an apparatus for automated mounting of ladder steps in well equipment, which apparatus comprises a frame construction 1 that comprises a vertical frame consisting of two columns 2 and a top beam 3 that serves as upper connector element for the two columns and wherein there is, between the columns 2, arranged a horizontal beam 4 that is journalled to be vertically displaceable between the columns 2 by means of two guides 6 arranged on the columns and a number of rollers 6 configured on the beam. By means of the two hydraulic cylinders 7 the beam 4 can thus be displaced upwards and downwards along the columns 2 and be secured relative to the columns 2 at any height.

At the bottom of the columns 2, a rail groove is provided that consists of the two parallel rails 16 that enable a rail carriage 17 to be displaced towards the columns 2.

As will appear in particular from FIG. 1c, the beam 4 is configured as a frame that comprises two longitudinally extending stringers 8 that are, at each end, mutually connected by means of two end stringers 9. Between the two longitudinally extending stringers 8 on the beam 4 a sledge 9 is configured that can be displaced horizontally in the beam 4 by means of a set of rollers 10 that run in a guide configured therefor in the longitudinally extending stringers 8. Thereby the sledge 9 can, by means of a hydraulic cylinder 11, be displaced horizontally back and forth in the frame 4, and in principle it can be arranged in any position between the two end stringers 9.

As will appear in particular from FIG. 1, the sledge 9 constitutes the upper portion of a yoke that comprises, in addition to said sledge, a first arm 12 and a second arm 13, that are solidly mounted on the sledge 9 whereby the sledge 9 forms the spacer on the yoke that connects the two arms 12,13.

On the first arm 12 a number (herein five shown as an example) of ladder-step grippers 14 are solidly mounted and on the other arm 13 a corresponding number of holder-on means are mounted in the form of hydraulic cylinders 15.

Now, FIGS. 2a and b show a rail carriage 17 that is shown located on the above-mentioned set of rails 16 that extends towards the columns 2 on the apparatus 1 shown in FIG. 1 for mounting of ladder steps. Thus, the rail carriage 17 comprises a frame that is provided with a set of rail wheels 18 and having, on its top face, a carrier device 19 that is rotatably mounted about a shaft 20 on the frame 17 of the rail carriage. Hereby, and as illustrated, a piece of well equipment 21 can be positioned —that is shown herein in a sectional view—and from which it will appear that the well equipment 21 is provided with mounting apertures 22 for receiving anchoring elements on a ladder step (not shown). By combination of FIGS. 1 and 2 it can be derived that the shown well equipment 21 will be able to be displaced along the rail groove 16 towards the apparatus for mounting of ladder steps, and besides the well equipment can be rotated relative to this apparatus by means of the rotatable carrier device 19.

Besides, the preferred embodiment of the invention features a (not shown) drive device for controlling the mutual turning of the carrier device 19 relative to the frame 17 of the rail carriage, and hence relative to the ladder-step automaton 1.

As regards the shown well equipment 21 with the pre-formed mounting apertures 22 for receiving a ladder step, this well equipment as a part of the present invention is manufactured in a not shown manufacturing process wherein the ladder-steps apertures can be formed in the casting process as such, as is known eg fra WO patent application No. 9113214. The present invention not being, however, limited to any particular casting process, and any casting process being applicable, these aspects of the invention will not be described in further detail in this context.

Now FIGS. 3a and b show a ladder-step gripper, of which there are—as mentioned above—located five on the apparatus for mounting ladder steps shown in FIG. 1. Each of these ladder-step grippers comprises, as shown, two mounting flanges 23 that can be screwed tightly home on the first arm 12 on the ladder step automaton 1 shown in FIG. 1. The mounting flanges are configured such that they can be mounted in different positions on the arm 12 such that the ladder step grippers can be adjusted depending on the type of well equipment to be handled.

Relative to the mounting flanges 23, a gripper device is arranged that comprises a shelf device 24 on which a ladder step 25 (shown herein by a dotted line) can be mounted with its anchoring elements 26 extending from the shelf device 24. This shelf device is resiliently journalled relative to the mounting flanges 23, such that the shelf element can, to a certain extend, yield to the power influence and is thus able to compensate for various inaccuracies in the production, such as varying element thickness of the well equipment, varying dimensions of ladder steps, and varying positioning of mounting apertures on the well equipment.

Above the shelf device 24 a set of jaws are provided that are journalled in a shaft 28 relative to the shelf device 24 and in such a manner that the jaws 27 are able to secure the ladder step 25 against the above-mentioned shelf device 24. To this end there is, as shown, configured a hydraulic cylinder 29 that is able to influence the shaft 28 and thereby cause the jaws to rotate, and secure and release the ladder step 25, respectively. Thus, by means of the hydraulic cylinder 29 the jaws 27 can be influenced by a force that is sufficient for securing the ladder step; but being such, however, that small displacements of the ladder step 26 relative to the shelf device 24 are allowed in order to further absorb inaccuracies in the production as mentioned above.

As mentioned above, FIGS. 1a, b and c show the apparatus for mounting ladder steps 25 in well equipment 21 in a first state that occurs at an early stage in a production cycle. Thus, FIG. 1 shows the ladder step automaton 1 in a state in which ladder steps 25 are mounted in each of the ladder-step grippers 14, such that the anchoring elements 26 on the ladder steps 25 extend in a direction away form the first arm 12 and towards the second arm 13.

The mounting of ladder steps 25 in the individual ladder-step grippers 14 can be performed either manually or there can be configured a not shown automaton to this end.

Now, FIGS. 4a, b and c show the same apparatus as shown in FIG. 1. Here it is shown, however, that a rail carriage 17 with a piece of well equipment 21 is arranged at the ladder-step automaton 1, and wherein the beam 4 has, by means of the hydraulic cylinder 7, been raised and subsequently lowered to the position shown, wherein the first arm 12 with the ladder steps 25 secured in the ladder-step grippers 14 extends a distance down into the interior of the well equipment 21.

In a preferred embodiment (not shown) the first arm 12 features an optical sensor that is capable of recording the distance from the sensor to the well equipment 21 and of finding at least one of the shown mounting apertures 22 in the well equipment 21. The latter functionality can, in a convenient embodiment, be performed by use of a laser-measurement device attached to the first arm 12, and by raising and lowering, respectively, the first arm 12 while simultaneously the well equipment 21 is rotated back and forth by means of the rotatable carrier device 19, until the location of the afore-mentioned aperture has been recorded.

Now the individual ladder steps 25 and their anchoring means 26 can be positioned correctly opposite the respective mounting apertures 22, and the anchoring means can, as shown in FIGS. 5a, b and c, be pressed into the mounting apertures 22 by the holder-on means being, by means of the hydraulic cylinders 15, capable of pressing the well equipment 21 towards the ladder steps 25.

As shown in FIGS. 4 and 5 the pressing action is obtained by the well equipment 21 being kept on the same position relative to the rail path 16, and by the yoke with the fixed arms 12 and 13 being displaced relative to the beam 4 while simultaneously the holder-on means are displaced opposite the yoke and at a corresponding velocity and travelling by means of the hydraulic cylinders 15. This process continues until the ladder steps 25 have been pressed a predetermined distance into the well equipment 21, which can optionally be recorded by means of the above-mentioned (not shown) optical sensor.

As shown in the figures the individual ladder step grippers can be mounted at varying distances from the first arm 12, such that the ladder-step grippers can be adjusted to optional mounting of ladder steps in well equipment with varying diameters or element thicknesses.

Now the ladder-step grippers are able to release the individual ladder steps, and the ready-mounted well equipment can be removed from the ladder-step automaton 1, following which the afore-mentioned process can be repeated with a renewed piece of well equipment.

1. A method of manufacturing well equipment with permanently mounted ladder steps (25) or the like in the well equipment, which method comprises filling of a mould cavity formed by a number of mould elements that comprise at least a mould core and an outer mould, and wherein the mould core is removed following filling of the mould cavity, and where mould parts are used for creating said mould cavity, said mould parts comprising mould elements, which will, following discharge of the cast well equipment, leave a number of mounting apertures (22) in the well equipment, characterised in that the positioning of the mounting apertures (22) in the well equipment is found by means of sensors intended therefor, and by the ladder steps (25) being, prior to being driven into the mounting apertures, shifted with a view to locating each ladder step opposite the mounting apertures into which they are to be driven, whereupon one or more ladder steps that are each provided with suitable anchoring elements (26) are driven into the well equipment.

2. A method according to claim 1, characterised in that the mounting apertures (22) formed in the casting process are subsequently further processed by a further drilling process by means of a drilling device intended therefor.

3. A method according to any one of the preceding claims, characterised in that the casting process uses mould elements for forming the mounting apertures (22) which mould elements are left in the well equipment following discharge of the well equipment, and wherein the mould elements have anchoring apertures that are configured with a view to receiving and securing the anchoring means configured on the ladder steps, and wherein the ladder steps are, following discharge of the well equipment with cast-in form elements, driven into the anchoring apertures of the mould elements.

4. A method according to any one of the preceding claims, characterised in that the ladder steps (25) are driven into the well equipment by means of an apparatus(1) that comprises a frame on which an arm (12) is configured on which a number of ladder step grippers (14) are configured that are each configured for receiving and securing at least one ladder step (25), and wherein the apparatus frame is further provided with holder-on means that extend opposite the above-mentioned holder-on means, and wherein the apparatus (1) comprises means for forming a substantially continuous and uninterrupted displacement of the ladder step grippers in a direction towards the holder-on means, and means for discontinuing this displacement at a predetermined distance between the ladder step grippers (14) and the holder-on means.

5. An apparatus for mounting ladder steps in apertures (22) in well equipment, characterised in that the apparatus (1) comprises a frame on which an arm (12) is configured on which a number of ladder step grippers (14) are configured that are each configured for receiving and securing at least one ladder step (25), and wherein the apparatus frame is further provided with holder-on means that extend opposite the above-mentioned ladder step grippers, and wherein the apparatus comprises means for forming a substantially continuous and uninterrupted displacement of the ladder step grippers in a direction towards the holder-on means, and means for discontinuing this displacement at a predetermined distance between the ladder step grippers (14) and the holder-on means, where the positioning of the mounting apertures (22) in the well equipment is found by means of sensors intended therefore, and where the ladder steps (25) are being, prior to being driven into the mounting apertures (22), shifted with a view to locating each ladder step opposite the mounting apertures into which they are to be driven.

6. An apparatus according to claim 5, characterised in that the ladder step grippers (14) are solidly mounted on the first arm (12), and in that the means for forming the substantially continuous and uninterrupted reduction of the distance between the ladder step grippers and the holder-on means, consist of one or more drive means that are configured for relatively displacing the first arm with the ladder step grippers secured on the arm as a rigid unit in a direction towards the holder-on means.

7. An apparatus according to claim 6, characterised in that it comprises a yoke, which yoke has a spacer element (9) that is mounted in the frame of the apparatus (1), and wherein the spacer element is configured with two downwardly extending arms (12,13) that are located at a substantially fixed mutual distance on the spacer element, and of which the one arm constitutes the afore-mentioned first arm (12) and the second arm (13) comprises the afore-mentioned holder-on means.

8. An apparatus according to one of claims 5 to 7, characterised in that means are configured for displacing the holder-on means away from the second arm (13) of the yoke and in a direction towards the first arm (12).

9. An apparatus according to one of claims 5 to 8, characterised in that the first arm (12) is located to be substantially vertically displaceable relative to the apparatus frame.

10. An apparatus according to any one of claims 5 to 9, characterised in that the first arm (12) is configured with a sensor with a view to localising the location of mounting apertures (22) in the well equipment.

11. An apparatus according to any one of claims 5 to 10, characterised in that it comprises a device (19) for supporting the well equipment, which device is mounted rotatably relative to the apparatus frame, such that the well equipment can be rotated about a substantially vertical axis that extends within the walls of the well equipment.

12. An apparatus according to one of claims 5 to 11, characterised in that the ladder step grippers (14) are configured in such a manner that the ladder steps (25) secured in the ladder step grippers can be displaced individually a limited distance in all directions relative to the first arm (12).

13. An apparatus according to one of claims 5 to 12, characterised in that the ladder step grippers (14) can be mounted on the first arm (12) at a different distance there from.
